(19) United States
(12) Patent Application Publication
(10) Pub. No.: US 2014/0264204 A1
(43) Pub. Date: Sep. 18, 2014

(54) EXPOSED HEADED-ELEMENT PULLING APPARATUS

(71) Applicant: JASON W. KITTELL, MORRISVILLE, VT (US)

(72) Inventor: JASON W. KITTELL, MORRISVILLE, VT (US)

(21) Appl. No.: 13/837,459

(22) Filed: Mar. 15, 2013

(51) Int. Cl. B25C 11/00

(52) U.S. Cl. CPC B25C 11/00
USPC 254/18; 254/133 R

(57) ABSTRACT

The present application is directed to an exposed headed-element pulling apparatus for pulling exposed headed-elements such as double headed nails from embedding material. The apparatus comprises a hooking element having a blow nozzle. The hooking element is connected to a linear actuator. A spacer element is integrated with the linear actuator to provide an opposing force against the embedding material when pulling the embedded exposed-headed element. Exposed headed-elements are pulled by the apparatus and then ejected by the blow nozzle through an ejection slot in the spacer element. Pulled headed-element can be collected in an attached bag for reuse. An optional rotation mechanism may be incorporated for more ergonomic pulling capabilities.

### FIELD

This patent application generally relates to an embedded element pulling apparatus for pulling exposed headed-elements from embedding material. More specifically it relates to an exposed headed-embedded element pulling apparatus having a hooking element for hooking the head of the embedded element, a linear actuator for moving the hooking, element, and a spacer element integrated with the linear actuator to provide an opposing force against the embedding material when pulling the embedded exposed-headed element.

### BACKGROUND

Typically double headed nails are used for temporary fastening of building structures such as concrete forms, scaffolding, temporary displays, etc. In some situations the craftsman needs to remove only a few nails that may have been driven into the wood. For these situations the use of the claws of a hammer or a crowbar are sufficient to remove the double headed nails. However, in other situations such as setting up concrete forms or scaffolding, hundreds of nails may need to be removed. Using a hammer or crowbar to remove a large number of nails is time consuming, has safety issues, usually damages the wood and tends to bend the nails so that they cannot be easily reused. The current patent application provides for a new tool that greatly reduces the time and effort of pulling double headed nails, maximizes safety, minimizes the damage to the wood and allows the double headed nails to be reused multiple times thereby offering significant cost saving to the user.

### SUMMARY

One aspect of the present patent application is directed to an exposed headed-element pulling apparatus for pulling exposed headed-elements from embedding material. The apparatus comprises a hooking element having a capture end and a connection end. The apparatus further comprises a linear actuator having a holding end, a driven end and a linear axis. The hooking element is connected by the connection end to the holding end of the linear actuator. A spacer element is integrated with the linear actuator to provide an opposing force against the embedding material when pulling the embedded exposed-headed element.

Another aspect of the present patent application is directed to a hooking element for hooking an exposed headed-element. The hooking element comprises a body having a capture end and a connection end, a shank slot with a head recess for hooking the exposed headed-element, a blow nozzle for ejecting the exposed headed-element out of the hooking element, and a fluid duct extending from the connection end to the blow nozzle.

### BRIEF DESCRIPTION OF DRAWINGS

The foregoing and other aspects and advantages presented in this patent application will be apparent from the following detailed description, as illustrated in the accompanying drawings, in which:

FIG. 1 is a perspective view of an exposed headed-element pulling apparatus according to the present patent application;

FIG. 2 is a side view of the exposed headed-element pulling apparatus in FIG. 1;

FIG. 3 is a front view of the exposed headed-element pulling apparatus in FIG. 1;

FIG. 4 is an exploded view of the exposed headed-element pulling, apparatus in FIG.

FIG. 5a is a side, sectional view along line A-A of FIG. 3 with additional surroundings, illustrating a first step in the pulling process;

FIG. 5b is a side, sectional view along line A-A of FIG. 3 with additional surroundings, illustrating a second step in the pulling process;

FIG. 5c is a side, sectional view along line A-A of FIG. 3 with additional surroundings, illustrating a third step in the pulling process;

FIG. 5d is a side, sectional view along line A-A of FIG. 3 with additional surroundings, illustrating a fourth step in the pulling process;

FIG. 5e is a side, sectional view along line A-A of FIG. 3 with additional surroundings, illustrating a fifth step in the pulling process;

FIG. 6a is a front view of the exposed headed-element pulling apparatus in FIG. 1, illustrating a first orientation of the hooking element, spacer element and bag relative to the rest of the apparatus;

FIG. 6b is a front view of the exposed headed-element pulling apparatus in FIG. 1, illustrating a second orientation of the hooking element, spacer element and bag relative to the rest of the apparatus;

FIG. 6c is a front view of the exposed headed-element pulling apparatus in FIG. 1, illustrating a third orientation of the hooking element, spacer element and bag relative to the rest of the apparatus;

FIG. 7a is a partial cutaway, side view of the exposed headed-element pulling apparatus in FIG. 1, without a bag, illustrating sectional views for FIGS. 7b-7e;

FIG. 7b is an enlarged view of the male side of the detent mechanism in FIG. 7d;

FIG. 7c is an enlarged view of the female side of the detent mechanism in FIG. 7e;

FIG. 7d is sectional view along line B-B showing the male side of the detent mechanism of the exposed headed-element pulling apparatus in FIG. 7a;

FIG. 7e is sectional view along line C-C showing the female side of the detent mechanism of the exposed headed-element pulling apparatus in FIG. 7a;

FIG. 7f is a sectional view along line D-D showing the male and female sides of the defeat mechanism engaged for the exposed headed-element pulling apparatus in FIG. 7a;

FIG. 7g is an enlarged view of the detent mechanism shown in FIG. 7f;

FIG. 8a is a perspective view of one embodiment of the booking element for the exposed headed-element pulling apparatus in FIG. 1;

FIG. 8b is a front view of one embodiment of the hooking element for the exposed headed-element pulling apparatus in FIG. 8a showing a key-shaped profile;

FIG. 8c is a sectional view along line E-E of the hooking element FIG. 8b;

FIG. 9a is a side, sectional view illustrating a first step in the operation of the quick release mechanism between the hooking element and linear actuator of the exposed headed-element pulling apparatus in FIG. 1;

FIG. 9b is a side, sectional view illustrating a second step in the operation of the quick release mechanism between the hooking element and linear actuator of the exposed headed-element pulling apparatus in FIG. 1;

FIG. 9c is a side, sectional view illustrating a third step in the operation of the quick release mechanism between the hooking element and linear actuator of the exposed headed-element pulling apparatus in FIG. 1;

FIG. 9d is a side, sectional view illustrating a fourth step in the operation of the quick release mechanism between the hooking element and linear actuator of the exposed headed-element pulling apparatus in FIG. 1;

FIG. 10a is a perspective view of the exposed headed-element pulling apparatus in FIG. 1, illustrating a first step in installing an optional bag with retainer;

FIG. 10b is a perspective view of the exposed headed-element, pulling apparatus in FIG. 1, illustrating a second step in installing an optional bag with retainer; and

FIG. 10c is a perspective view of the exposed headed-element pulling apparatus in FIG. 1, illustrating a third step in installing an optional bag with retainer.

### DETAILED DESCRIPTION

Exposed headed-element pulling apparatus 20 is shown in FIGS. 1-10c. Embedded element pulling apparatus 20 comprises a hooking element 22 for hooking exposed head 24 of exposed headed-element 25. Hooking element 22 is connected to linear actuator 26. Linear actuator 26 moves hooking element 22 along linear axis 28. A spacer element 32 is integrated with linear actuator 26 to provide an opposing force against embedding material 34 when pulling embedded exposed-headed elements 25. Spacer element 32 is provided with ejection slot 35 through which to eject pulled exposed headed-elements 25. An optional bag 36 can be aligned with ejection slot 35 to collect the pulled exposed headed-elements 25. Hooking element. 22 and spacer element 32 may be keyed to rotate with each other around linear axis 28 thereby allowing a user to customize the orientation of the hooking element for the most ergonomic removal of exposed headed-elements 25. Spacer element 32 extends from housing 38. Hooking element 22 and linear actuator 26 move together along linear axis 28 within spacer element 32. A handle 40 is provided to housing 38 for ease of holding apparatus 20. A trigger 41 is integrated with handle 40; the trigger activates linear actuator 26 via four-way valve 90 or a switch of another type. A pressure source 42 or other power source is provided through handle 40 to power linear actuator 26.

FIGS. 8a-8c show in detail the features of hooking element 22. Hooking element 22 has a body 43, a capture end 45 and a connection end 46. Hooking element 22 includes a shank slot 47 extending from capture end 45 towards connection end 46. Shank slot 47 is sized with a shank slot diameter 51 to hold the shank of the exposed headed-element 25. Hooking element 22 also includes a head recess 48 for hooking exposed head 24 of exposed headed-element 25. Head recess 48 has a head recess diameter 53. Head recess diameter 53 is greater than the shank slot diameter 51 in order to hold exposed head 24. A chamfer 49 may be provided across shank slot 47 on capture end 45 to aid in the capture and removal of toe nails, which are driven into a corner, or over driven nails. Hooking element 22 can be interchanged for removing different size and shaped nails.

A blow nozzle 50 may be provided as part of hooking element 22 to facilitate the ejection of exposed headed-elements 25 out of hooking element 22 once the exposed headed-elements have been removed from embedding material 34. Blow nozzle 50 is used in conjunction with pressure source 42. Blow nozzle 50 is connected to pressure source 42 by fluid duct 52 that runs through hooking element 22 from connection end 46 to the blow nozzle. Blow nozzle 50 has a deflecting surface 54 that is for diverting fluid perpendicular to fluid duct 52. Deflecting surface 54 is preferably a curved deflecting surface that is concave towards head recess 48. The curvature of deflecting surface 54 causes the diversion of fluid towards head recess 48. Curved deflecting surface 54 should have a radius of curvature larger than shank slot diameter 51 in order for the deflecting surface to effectively divert fluid. When pressure source 42 provides a fluid such as air through fluid duct 52, deflecting surface 54 diverts the fluid perpendicular to the fluid duct and activates blow nozzle 50 thereby providing a force that ejects a pulled exposed headed-element 25 from hooking element 22.

Hooking element 22 is connected to linear actuator 26 preferably via a quick release mechanism 56. Quick release mechanism 56 allows the user to customize apparatus 20 with different hooking elements 22 depending on the type and size of exposed headed-elements 25 that need to be removed. One exemplary type of quick release mechanism 56. FIGS. 9a-9d, comprises lock-ball holes 58 each paired with a lock ball 60. Lock pin 61 working in coordination with spring 63 positions lock balls 60 in locking recess 59 on holding end 62 of linear actuator 26. In this embodiment, capture end 45 has a capture end diameter 44 and connection end 46 has a connection end diameter 39, the capture end diameter 44 is larger than connection end diameter 39 to aid in mating connection end 46 to holding end 62. During a first step, FIG. 9a, quick release mechanism 56 is shown in the connected and locked position with lock balls 60 captured in locking recess 59 and lock pin 61 in the forward position. In a second step. FIG. 9b, force is applied to lock pin 61 allowing lock balls 60 to move toward the center and away from locking recess 59. In a third step, FIG. 9c, hooking element 22 is pulled out of holding end 62 of linear actuator 26. In a forth step, FIG. 9d, lock pin 60 is released and lock balls 60 return to their outer position. Other types of quick release mechanisms such as a captive screw in hooking element 22 and female thread in holding end 62 of linear actuator 26 may be used. When hooking element 22 is connected to linear actuator a fluid pathway is provided from pressure source 42 to blow nozzle 50 via fluid duct 52. Fluid duct 52 connects with connecting duct 64 of linear actuator 26 at exit orifice 66.

Hooking element 22 is coupled with spacer element 32. Spacer element 32 preferably surrounds hooking element 22. Hooking element 22 and linear actuator 26 move together along linear axis 28 within spacer element 32. Spacer element 32 is provided with ejection slot 35 along one side. Ejection slot 35 is aligned with shank slot 47 of hooking element 22. Exposed headed-elements 25 that have been pulled from embedding material 34 are ejected out of shank slot 47 through ejection slot 35 by the force of the fluid that exits blow nozzle 50. An optional bag 36 can be aligned with ejection slot 34 to collect pulled exposed headed-elements 25. Bag 36 may be fabricated from fabric made of natural or synthetic fibers, or plastic film such as TYVEK®. Bag 36 may be of glued, fused, or sewn construction. Bag 36 has a sleeve 67 for sliding over the outer surface of spacer element 32 and a pouch 69 for collecting exposed headed-elements 25. Bag 36 may be retained by a bag retainer 105 or adhesive to rotate with spacer element 32. FIGS. 10a-c. In FIG. 10a sleeve 67 of bag 36 is slid over spacer element 32 to completely encircle the spacer element as in FIG. 10b. Bag retainer 105 is then hingeably engaged to hold bag 36 in place, FIG. 10c.

Linear actuator 26 includes a rod 68 with an outer rod diameter 70. Outer rod diameter 70 is greater than or equal to capture end diameter 44 of hooking element 22 to eliminate an pinch point between the hooking element and housing 38. Spacer element 32 is sized to surround outer rod diameter 70. Linear actuator has a holding end 62 and a driven end 72. Holding end 62 is connected to booking element 22. Driven end 72 is connected to a piston 74 that resides within housing 38. Housing 38 has a front end 71 and a back end 73. Piston 74 moves within cylinder 75. Connecting duct 64 is located within rod 68. Connecting duct 64 has an entrance orifice 76 on outer rod diameter 70 and an exit orifice 66 on holding end 62. Rod seal 78 seals around rod 68 at the location where the rod enters spacer element 32. Rod seal 78 and entrance orifice 76 together create an ejection valve 80 that activates a source of fluid from pressure source 42 to blow fluid through blow nozzle 50. Pressurized fluid 79 may alternately be provided by an integrated pump or pressure storage chamber.

Linear actuator 26 may a pneumatic linear actuator as shown in FIGS. 5a-5e. As a pneumatic linear actuator 26, piston 74 is driven between front end 71 and back end 73 of housing 38 by a pressure source 42. Pressure source 42 may be a pressurized fluid 79 such as high pressure air, CO₂, water, steam or other fluid. Pressure source 42 attaches to pressure inlet 82. Pressurized fluid 79 flows through pressure source tube 84. Pressure source 42 provides the motive force for moving linear actuator 26. Two chambers are provided within cylinder 75, a retraction chamber 86 and an extension chamber 88. A four-way valve 90 is incorporated into handle 40 to regulate fluid flow into and out of cylinder 75. Four-way valve 90 may be a valve such as a Parker Brand model no, 410811000. Pressurized fluid 79 enters retraction chamber 86 through retraction chamber pressure port 92. Pressurized fluid 79 can also enter extension chamber 88 through extension chamber pressure port 94. Exhaustion of fluid may occur through retraction chamber pressure port 92, extension chamber pressure port 94 and exhaust port 96. It is understood that linear actuator 26 could be any one of a wide variety of alternative linear actuators that operate by using mechanical, electric, magnetic, hydraulic, pneumatic and explosive principles.

For a pneumatic linear actuator 26 as shown in FIGS. 5a-5e, the associated pressure source 42 also provides the ejection force for ejecting pulled exposed headed-elements 25. In embodiments where the linear actuator uses non-pneumatic motive forces, a separate pressurized fluid source can be provided to activate blow nozzle 50.

One feature of apparatus 20 is to have hooking element 22 and spacer element 32 rotate together around linear axis 28 to allow the user to customize the orientation of the hooking element for the most ergonomic removal of exposed headed elements 25, FIGS. 6a-6c. To do this, hooking element 22 and spacer element 32 are keyed to rotate with each other around linear axis 28 thereby maintaining the relationship between shank slot 47 and ejection slot 35. Hooking element 22 may have a keyed-shape such as shown in FIG. 8b that keys within the same internal keyed-shape of spacer element 32 so these two elements are forced to move together when rotated around linear axis 28. A rotation mechanism is provided to allow the user to set the angle of handle 40 relative to hooking element 22. Rotation mechanism may be a frictional mechanism or a detent mechanism 100. FIGS. 7a-f shows a detent mechanism 100 integrated with apparatus 20. Detent mechanism 100 includes a male detent element 102 fixed to move with spacer element 32. Opposite male detent element 102 are female deem elements 104 in housing 38 that move with handle 40. Detent spring 103 acting between spacer element 32 and housing 38 acts to keep male detent element 103 in contact with female detent element 104. The user grips spacer element 32 and applies a rotational force around linear axis 28 to rotate male detent elements 102 to fit with an appropriate female detent element 104 to set hooking element 22 to the proper angle relative to handle 40.

Operation of exposed headed-element pulling apparatus 20 is as follows. With apparatus 20 connected to pressure source 42, and when trigger 41 is not been activated, the apparatus is in a ready state. In a first step, FIG. 5a, the user first hooks hooking element 22 onto an embedded exposed headed-element 25. The user then applies force to trigger 41 which activates four-way valve 90 to allow pressurized fluid 79 such as compressed air at 100 PSI to enter through pressure inlet 82. Pressurized fluid 79 (shown as denser pattern in figures) flows through pressure source tube 84, through four-way valve 90, through retraction chamber pressure port 92, and then further flows into retraction chamber 86. Piston 74 moves away from front end 71 of housing 38 and away from embedded surface 110. Arrows in figures show direction of movement for piston 74 and trigger 41. Retraction chamber 86 expands and extension chamber 88 contracts. Low pressure fluid 112 (shown as less denser pattern in figures) exits extension chamber 88 through extension chamber pressure port 94, four-way valve 90 and then out through exhaust port 96 in handle 40. The movement of piston 74 away from embedded surface 110 retracts rod 68 and hooking element 22 away from embedded surface 110. Spacer element 32 provides an opposing force against embedding material 34. This combined action causes exposed headed-element 25 to be removed from embedding material 34.

In a second step, FIG. 5b, exposed headed-element 25 has been pulled out of embedding material 34, but is still held by hooking element 22. At this stage retraction chamber 86 is expanded still further so that entrance orifice 76 passes beyond rod seal 78 allowing a portion of pressurized fluid 79 from retraction chamber 86 to enter connecting duct 64. This portion of pressurized fluid 79 flows through fluid duct 52, is deflected from deflecting surface 54 and applies a force to head 24 of exposed headed-element 25 thereby ejecting the exposed headed element from shank slot 47 of hooking element 22. Exposed headed-element 25 is further ejected through ejection slot 35 of spacer element 32 and the exposed headed-element is collected in bag 36.

In a third step, FIG. 5c, piston 74 reaches the back end 73 of housing 38. Retraction chamber 86 is fully extended and essentially all fluid has been exhausted from extension chamber 88.

In a fourth step, FIG. 5d, trigger 41 is released by the user. Release of trigger 41 activates four-way valve 90 so that pressurized fluid 79 flows through pressure source tube 84, through four-way valve 90, through extension chamber pressure port 94, and then flows into extension chamber 88. Piston 74 moves away from hack end 73 of housing 38. Extension chamber 88 expands while retraction chamber 86 contracts. Low pressure fluid 112 exits retraction chamber 86 through retraction chamber pressure port 92, through four-way valve 90 and out through exhaust port 96 in handle 40.

In a fifth step, FIG. 5e, piston 74 reaches the front end 71 of housing 38. Extension chamber 88 is fully extended and essentially all fluid has been exhausted from retraction chamber 86. Apparatus 20 is now ready for hooking onto another exposed headed-element and the five step sequence just described is repeated for each time that an exposed headed-element is removed. Exposed headed-elements 25 that have been pulled can then be removed from bag 36 and reused.

Exposed headed-element pulling apparatus 20 has several benefits over prior art devices, for example this apparatus allows external power to aid the user in removing embedded exposed headed-elements giving the user an ergonomic way to bring that power to bear on removing the exposed headed-elements.

While several embodiments of the invention, together with modifications thereof, have been described in detail herein and illustrated in the accompanying drawings, it will be evident that various further modifications are possible without departing from the scope of the invention. Nothing in the above specification is intended to limit the invention more narrowly than the appended claims. The examples given are intended only to be illustrative rather than exclusive.

What is claimed is:

1) An exposed headed-element pulling apparatus for pulling exposed headed-elements from embedding material, comprising:
a) a hooking element having a capture end with a capture end and a connection end;
b) a linear actuator having a holding end, a driven end and a linear axis, said hooking element connected to said holding end; and
c) a spacer element, said spacer element integrated with said linear actuator to provide an opposing force against the embedding material when pulling the embedded exposed headed element.

2) An apparatus as recited in claim 1, wherein said hooking element includes a shank slot with a head recess for hooking the exposed headed-element

3) An apparatus as recited in claim 2, wherein said hooking element further includes a chamfer across said shank slot on said capturing end.

4) An apparatus as recited in claim 1, wherein said hooking element includes a blow nozzle for ejecting exposed-headed elements out of said hooking element.

5) An apparatus as recited in claim 1, further comprising a fluid duct running through said hooking element from said capture end to said blow nozzle.

6) An apparatus as recited in claim 5, wherein said blow nozzle further includes a deflecting surface, wherein said deflecting surface is for diverting a fluid perpendicular to said duct.

7) An apparatus as recited in claim 6, further comprising a pressure source, wherein said pressure source is the fluid that activates said blow nozzle.

8) An apparatus as recited in claim 1, further comprising a quick release mechanism connecting said hooking element to said linear actuator.

9) An apparatus as recited in claim 1, wherein said spacer element surrounds said hooking element.

10) An apparatus as recited in claim 9, wherein said spacer element has an ejection slot through which to eject the exposed-headed element.

11) An apparatus as recited in claim 9, wherein said spacer element and said hooking element are keyed to rotate with each other around said linear axis.

12) An apparatus as recited in claim 11, further including a rotation mechanism for holding a rotational position around said linear axis.

13) An apparatus as recited in claim 11, wherein said rotation mechanism is a detent mechanism or frictional mechanism.

14) An apparatus as recited in claim 1, wherein said linear actuator further includes a rod having an outer rod diameter.

15) An apparatus as recited in claim 14, further including a housing.

16) An apparatus as recited in claim 15, wherein said capture end has a capture end diameter, wherein said outer rod diameter is greater than or equal to the capture end diameter to eliminate a pinch point between said hooking element and said housing.

17) An apparatus as recited in claim 14, wherein said spacer element, is sized to surround said outer rod diameter.

18) An apparatus as recited in claim 1, wherein said linear actuator includes a rod having a connecting duct located within said rod.

19) An apparatus as recited in claim 18, wherein said connecting duct has an entrance orifice on said outer rod diameter and an exit orifice on said holding end.

20) An apparatus as recited in claim 19, further comprising an ejection valve, wherein said ejection valve includes said entrance orifice and a rod seal around said rod.

21) An apparatus as recited in claim 1, further comprising a pressure source, wherein said pressure source provides the motive force for said linear actuator.

22) An apparatus as recited in claim 22, wherein said pressure source is a pressurized fluid.

23) An apparatus as recited in claim 1, further comprising a handle.

24) An apparatus as recited in claim 1, further comprising a bag for collecting exposed-head nails.

25) An apparatus as recited in claim 1, further comprising a bag retainer for retaining a bag to said spacer element.

26) A hooking element for capturing an exposed headed-element, comprising:
a) a body having a capture end and a connection end;
b) a shank slot with a head recess for hooking the exposed headed-element;
c) a blow nozzle for ejecting the exposed headed-element out of said hooking element; and
d) a fluid duct extending from said connection end to said blow nozzle.

27) An apparatus as recited in claim 26, wherein said body has a capture end diameter and a connection end diameter, wherein said capture end diameter is larger than said connection end diameter.

28) An apparatus as recited in claim 26, further comprising a keyed-shape profile for keying with a surrounding spacer element.

29) An apparatus as recited in claim 26, further comprising lock-ball holes on said connection end for accepting locking balls of a quick-release mechanism.

30) An apparatus as recited in claim, wherein said shank slot extends from said capture end towards said connection end.

31) An apparatus as recited in claim 26, wherein said shank slot has a shank slot diameter and said head recess has a head recess diameter, wherein said head recess diameter is greater than said shank slot diameter.

32) An apparatus as recited in claim 26, wherein said blow nozzle further includes an deflecting surface, wherein said deflecting surface is for diverting fluid perpendicular to said fluid duct.

33) An apparatus as recited in claim 32, wherein said fluid deflecting surface is a curved deflecting surface that is concave towards said head recess.

34) An apparatus as recited in claim 33, wherein said shank slot has a shank slot diameter, wherein said curved deflecting surface has a radius of curvature larger than said shank slot diameter.

35) An apparatus as recited in claim 26, further comprising a chamfer across said shank slot on said capturing end.
